(19) United States
(12) Patent Application Publication
(10) Pub. No.: US 2018/0111208 A1
(43) Pub. Date: Apr. 26, 2018

(54) METHOD AND DEVICE FOR CRUSHING METAL DROSS BLOCKS AND/OR METAL EXTENSIONS

(71) Applicant: GAUTSCHI ENGINEERING GMBH, Berg (CH)

(72) Inventors: Jochen BRACKMEYER, Bodman-Ludwigshafen (DE); Willy Werner ZELLER, Kreuzlingen (CH)

(73) Assignee: GAUTSCHI ENGINEERING GMBH, Berg (CH)

(21) Appl. No.: 15/562,227

(22) PCT Filed: Mar. 26, 2016
(86) PCT No.: PCT/EP2016/056352

§ 371 Date: Sep. 27, 2017

(30) Foreign Application Priority Data
Mar. 27, 2015 (DE) 10 2015 104 770.5
Aug. 5, 2015 (DE) 10 2015 112 844.6

(51) Int. Cl. B23D 57/00

(52) U.S. Cl. CPC B23D 57/0007

(57) ABSTRACT

A method for crushing a metal dross block and/or metal extension uses a cable saw to at least tartly cut the metal dross block and/or metal extension.

### BACKGROUND OF THE INVENTION

### 1. Field of the Invention

The invention relates to a method and a device for comminuting a metal dross block and/or metal run-out. The invention further relates to the use of a separating machine for comminuting a metal dross block and/or metal run-out and to a metal dross block and/or metal run-out.

### 2. Discussion of the Related Art

During the operation of a smelting furnace of a primary smelter, there can occur run-out of the metal melt situated in the electrolysis furnace. The metal melt which has run out accumulates in the foundation of the furnace and solidifies there. In another case, in secondary smelters, metal dross blocks are formed by the removal of residual melt from the furnaces or casting channels or by the scraping-off of a melt bath. Comminution customarily takes place with percussion hammers or shears or oxygen burner lances. The problem here is that, as a result, the foundation of the furnace or of the location of the comminution is damaged and has to be re-established within short intervals.

### SUMMARY OF THE INVENTION

It is an object of the invention to specify a method and a device by means of which metal dross blocks and/or metal run-outs can be comminuted gently and quickly. It is a further object of the invention to specify a use of a separating machine for comminuting a metal dross block and/or metal run-out, and a metal dross block and/or metal run-out.

The invention is based on the idea of specifying a method for comminuting a metal dross block and/or metal run-out, wherein the metal dross block and/or metal run-out are or is at least partially cut out by a wire saw.

The solid metal dross block and/or metal run-out has a weight of about 10 kg to several 100 kg, for example up to 500 kg or more.

The method according to the invention has the advantage that the foundation on which the metal dross block and/or metal run-out lies is spared during comminution because, by comparison with comminution with percussion hammers, shears and oxygen lances, on the one hand, very much lower forces are introduced into the floor and, on the other hand, by comparison with comminution with shears and burner lances, the foundation is less strongly stressed. In addition, comminution of the metal dross block and/or metal run-out by means of the wire saw is quicker and more effective than by means of a percussion hammer or the stated alternatives. Since, in the prior art, the percussion hammers are customarily mounted on an excavator, the required equipment for comminuting the respective metal dross block and/or metal run-out is also uncomplicated if a wire saw is used.

Although wire saws are known per se from the prior art, for example, DE 10 2007 008 124 A1, and are used for example for sawing up natural stones, it has been found, surprisingly, that the use of a wire saw in metallurgy for sawing up solid metal dross blocks and/or metal run-outs has the aforementioned significant advantages.

Preferred embodiments of the method are specified in the subclaims. Thus, after cutting-up, the comminuted metal dross block and/or metal run-out can be further treated to recover the metal contained therein. The wire saw allows the metal dross block and/or metal run-out to be sawn up into small pieces which are then very suitable for further treatment. Before cutting-up, the metal dross block and/or metal run-out can be removed from the foundation of the melting furnace and fed to the wire saw. The wire saw can thus be placed at a favorable location in the region of the installation, with the result that sawing-up is simplified. The metal dross block and/or metal run-out are or is removed from the foundation by lifting the block/run-out with a crane or excavator. For lifting-out purposes, it is possible, for example, for a threaded bore to be cut into the block/run-out and have a hook screwed therein.

In a preferred embodiment, a saw wire of the wire saw is guided from one side, in particular from the upper side of the metal dross block and/or metal run-out, through the latter in the direction of the floor. This makes it possible in a particularly simple manner for pieces to be cut out of the metal dross block and/or metal run-out.

A device for comminuting a metal dross block and/or metal run-out is claimed within the scope of the invention. The device has a wire saw, a base frame and a yoke which is pivotably fastened to the base frame and guides a saw wire. According to the invention, the base frame has a securing means for the metal dross block and/or metal run-out. The device according to the invention is suitable and provided for carrying out the method according to the invention and has the advantages described in conjunction with the method according to the invention.

In a particularly preferred embodiment, the securing means forms a stop for the metal dross block and/or metal run-out in the running direction of the saw wire. The securing means can form a substantially vertical plate which is connected to the base frame. This type of securing is simple, effective and robust.

The yoke can have at least two, in particular three, arms, wherein the saw wire extends freely between two arm ends. The yoke forms a framework which is pivoted over the metal dross block and/or metal run-out in order to cut the latter, with the result that the saw wire comes into contact with the metal dross block and/or metal run-out. A first arm of the yoke preferably has a multiple roller guide for the saw wire, with the result that the latter is reliably deflected.

The use of a separating machine for comminuting a metal dross block and/or metal run-out is also claimed within the scope of the invention, wherein the separating machine has a wire saw. The use of this separating machine leads to the advantages explained in conjunction with the method.

In a preferred embodiment, the wire saw is a mobile wire saw or a stationary wire saw. The mobile wire saw has the advantage that it is brought to the respective location of use only as required. The stationary wire saw can be designed for a greater power than the mobile wire saw and is suitable for correspondingly larger installations in which large blocks are to be comminuted.

The wire saw can have a saw wire with abrasive elements in the form of diamonded beads. It has been shown, surprisingly, that such a saw wire makes it possible for metal dross blocks and/or metal run-outs to be readily broken up. The saw wire with abrasive elements in the form of diamonded beads is also disclosed and claimed in conjunction with the device for comminuting a metal dross block and/or metal run-out, specifically in conjunction with all embodiments.

A comminuted metal dross block and/or metal run-out which is sawn up by a wire saw is also claimed within the scope of the invention. The metal dross block and/or metal run-out according to the invention can be distinguished by the relatively smooth cut surfaces of the wire saw, which can thus not be produced with other separating machines, in particular with percussion hammers. The metal dross block and/or metal run-out according to the invention that is sawn up by the wire saw is particularly readily suited for further processing and transport.

### BRIEF DESCRIPTION OF THE DRAWING

The invention will be explained more fully with further details in conjunction with the single schematic figure.

FIG. 1 shows a side view of a device for comminuting metal dross blocks and/or metal run-outs.

### DETAILED DISCUSSION OF THE INVENTION

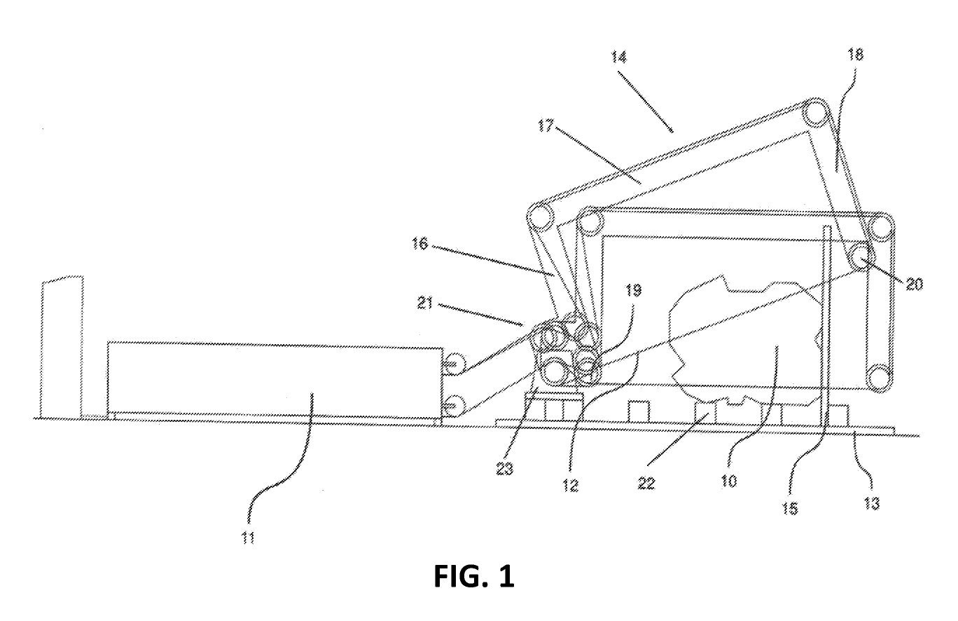

The method according to the invention for comminuting a metal dross block and/or metal run-out 10 can be carried out for example with the device illustrated in the FIG. 1. Other devices, for example mobile wire saws, are possible for carrying out the method. The stationary wire saw 11 shown in the FIG. 1 is particularly suitable for comminuting large metal dross blocks and/or metal run-outs 10. The shape of the metal dross blocks and/or metal run-outs to be comminuted is virtually arbitrary.

A metal dross block and/or metal run-out are or is a solidified metal block which is formed by run-out or conveyed-out metal or metal oxide or impurities or a mixture thereof from a smelting furnace or liquid metal furnace or an electrolysis furnace. Dross is generally a metal-type product which arises during the melting and processing of metals and is recycled as a secondary raw material for metal recycling. The metal dross block and/or metal run-out shown in the FIG. 1 are or is for example an aluminum block which, upon run-out in a melting furnace, has formed in the foundation of the furnace. The block is removed from the foundation and fed to the wire saw.

The method is based on the fact that the metal dross block and/or metal run-out 10 are or is cut up by a wire saw 11.

The method is explained by way of example on the basis of the device which is shown in the FIG. 1 and which is built up as follows. The device has a wire saw 11 which comprises, in a manner known per se, a drive, a feed mechanism and a wire store. These components are not illustrated in the FIG. 1 and are situated in the housing of the wire saw 11. Beside the wire saw 11, there is provided an operator panel for the wire saw (no reference sign). In addition to the wire saw 11, the device has a base frame 13 which is arranged separately next to said wire saw. The base frame 13 forms the bearing surface for the metal dross block and/or metal run-out 10. For this purpose, the base frame 13 has a plurality of beams 22 on which the metal dross block and/or metal run-out 10 rests. Another support for the metal dross block and/or metal run-out 10 is possible. Pivotably fastened to the base frame 13 is a yoke 14 which serves as a guide for the saw wire 12. The yoke has three arms 16, 17, 18, wherein a first arm 16 is pivotably connected to a bearing block 23. The second arm 17 extends substantially at a right angle to the first arm 16 and determines the length of the yoke 14. The third arm 18 is mounted at the end of the second arm 17 and extends substantially parallel to the first arm 16. The saw wire 12 extends freely between the end 19 of the first arm 16 and the end 20 of the second arm 17. The saw wire 12 extends parallel to the second arm 17. Other yoke forms are possible.

Provided on the first arm 16 is a multiple roller guide 21 for the saw wire 12, said guide guiding the forward and rearward running of the wire saw 12 out of or into the wire saw 11. Provided in the corners of the yoke 14 are further deflection rollers which have the effect of guiding the saw wire along the yoke 14 or in the yoke 14.

The yoke 14 is pivotable and acts as a lever. The FIG. 1 shows two pivoting positions of the yoke 14, wherein, in the first upper position, the saw wire 12 penetrates from the upper side of the metal dross block and/or metal run-out 10 into the latter and, in the second lower position, can extend parallel to the floor. The saw wire 12 does not necessarily have to cut up the complete metal dross block and/or metal run-out 10. It is sufficient if the metal dross block and/or metal run-out 10 is at least partially cut up, with the result that the complete severing of the metal dross block and/or metal run-out 10 can occur in some other way, for example using wedges.

It has been shown that a saw wire with abrasive elements in the form of diamonded beads allows a sufficient cutting action for sawing up a metal dross block and/or metal run-out, in particular an aluminum-containing metal dross block and/or metal run-out.

As can be seen in the FIG. 1, the base frame 13 has a plate 15 which serves as a stop for the metal dross block and/or metal run-out 10. The plate 15 is arranged substantially vertically and is connected by one end to the base frame, for example to a beam 22 of the base frame 13. During operation, the metal dross block and/or metal run-out butts against the plate 15 and is thereby fixed in the sawing direction.

The method described above and the device explained for carrying out the method afford an appreciable cost reduction since repair costs for the foundation and, where appropriate, for the construction machines used therefor are minimized and comminution occurs more quickly and more securely. The use of a wire saw in metallurgy makes these advantages possible.

### LIST OF REFERENCE SIGNS

10 Metal dross block and/or metal run-out

11 Wire saw

12 Saw wire

13 Base frame

14 Yoke

15 Plate

16 First arm

17 Second arm

18 Third arm

19, 20 Arm ends

21 Multiple roller guide

22 Beam

23 Bearing block

1. A method for comminuting a metal dross block or a metal run-out, the method comprising the step of:
(a) at least partially cutting up by a wire saw the metal dross block or the metal run-out to form a comminuted metal dross block or a comminuted metal run-out.

2. The method as claimed in claim 1, further comprising performing after step (a) the step of
treating the comminuted metal dross block or the comminuted metal run-out to recover the metal contained therein.

3. The method as claimed in claim 1, further comprising performing before step (a) the step of
removing from a foundation of an electrolysis furnace and feeding to the wire saw the metal dross block or the metal run-out.

4. The method as claimed in claim 1, further comprising performing before step (a) the step of
removing from a dross container and feeding to the wire saw the metal dross block or the metal run-out.

5. The method of claim 1, wherein step (a) is performed by
guiding a saw wire of the saw wire from an upper side of the metal dross block or the metal run-out through another side in a direction of a floor.

6. A device for comminuting a metal dross block or a metal run-out, the device comprising:
a wire saw comprising a saw wire;
a base frame
a yoke pivotally fastened to the base frame, the yoke guiding the saw wire; and
wherein the base frame comprises a securing means for the metal dross block or the metal run-out.

7. The device as claimed in claim 6, wherein the securing means forms a stop for the metal dross block or the metal run-out in a running direction of the saw wire.

8. The device as claimed in claim 6, wherein the securing means forms a substantially vertical plate, the vertical plate being connected to the base frame.

9. The device as claimed in claim 6,
wherein the yoke comprises two arms, each arm having an arm end;
wherein the saw wire extends freely between two arm ends.

10. The device as claimed in claim 9, wherein the yoke comprises a first arm, the first arm comprises a multiple roller guide for the saw wire.

11.-14. (canceled)

15. The device as claimed in claim 6,
wherein the yoke comprises three arms, each arm having an arm end;
wherein the saw wire extends freely between two arm ends.
